(19) United States
(12) Patent Application Publication
(10) Pub. No.: US 2019/0314867 A1
(43) Pub. Date: Oct. 17, 2019

(54) AUTOMATIC UNDERCARRIAGE SPRAYER

(71) Applicants: Casey Kauffman, Beech Grove, IN (US); Emma Rose Sloan, Indianapolis, IN (US); Melinda Joan Gieringer, Zionsville, IN (US); Dustin Ortega, Indianapolis, IN (US); Jasmine Moody, Indianapolis, IN (US)

(72) Inventors: Casey Kauffman, Beech Grove, IN (US); Emma Rose Sloan, Indianapolis, IN (US); Melinda Joan Gieringer, Zionsville, IN (US); Dustin Ortega, Indianapolis, IN (US); Jasmine Moody, Indianapolis, IN (US)

(21) Appl. No.: 15/954,057

(22) Filed: Apr. 16, 2018

(51) Int. Cl. B08B 3/02; B05B 14/00

(52) U.S. Cl. CPC B08B 3/022; B05B 14/00

(57) ABSTRACT

Vehicle undercarriage cleaners clean the undercarriage of vehicles. Dirt, mud, Salt, chemicals, Snow and other materials accumulate on the undersides of vehicles. This vehicle undercarriage cleaner removes these materials without requiring the user to manipulate it during use. A sensor at the front of the system is used to tell when a vehicle is passing over. As the vehicle passes over a row of nozzles, aiming upwards, connected to a water pump, is activated removing any debris from the undercarriage.

### TECHNICAL FIELD

The present application relates to car cleaning apparatuses, and more particularly to apparatuses for cleaning the underbody of a car.

### BACKGROUND

The use of pressurized liquid to clean debris from a vehicle's undercarriage has long been widespread in the field. Examples include commercial car wash facilities, and manual undercarriage cleaners, both of which spray cleaning solution at high velocity toward the vehicle's undercarriage. This method of cleaning a vehicle's undercarriage has been utilized for decades, and are common within the art.

Present options for cleaning a vehicle's undercarriage are largely limited to commercial car wash facilities. For people who prefer not to use commercial car wash facilities, there exist in the market products that require manually rolling a rack of spray nozzles underneath the vehicle. This can be cumbersome, and requires a minimum physical competency, rendering the product useless to people who lack the physical ability to maneuver the product.

In regions with harsh winters, snow and ice can accumulate daily and become difficult to remove. This in combination with deicing methods such as salt can cause serious damage to vehicles potentially even rendering the vehicle unusable.

There is, therefore an unmet need for a novel method to remove debris from the undercarriage of a vehicle, without reliance on commercial car wash facilities or manual labor. This need will be met by an undercarriage car wash system conveniently located in a home garage.

### SUMMARY

The general purpose of the invention is to provide a system and method to cleaning the undercarriage of a vehicle that overcomes many of the disadvantages of the previously mentioned prior art, while being novel and non-obvious. The prior art requires either manual labor or the use of a commercial car wash to clean the undercarriage of a vehicle. The system and method of the present invention overcomes these limitations.

The invention generally comprises of a system having a housing for the vehicle to drive over or be parked on. Sensors used to detect when the housing is being driven over. The housing is integrated with spray nozzles directed at the undercarriage of the vehicle.

Before explaining the embodiments of the invention it should be understood that the invention is capable of other embodiments and is not to be limited by the terms and phrases used in the description.

The primary purpose of the invention is to provide a system and method to cleaning the undercarriage of a vehicle that overcomes the limitations of the mentioned prior art.

A second objective is to provide a system and method of cleaning the undercarriage of a vehicle that removes dirt, snow, and road debris from the undercarriage of a vehicle with minimal manual labor.

The accompanying drawings and figures are illustrative of one embodiment and do not encompass all possible embodiments of the invention. Furthermore, the accompanying drawings are not to be taken as limiting in any way to the implementations of the invention.

### BRIEF DESCRIPTION OF DRAWINGS

FIG. 1 is an isometric view of the preferred embodiment.

FIG. 2 is an isometric view of the preferred embodiment using a planar cut to see the inside of the housing.

FIG. 3 is an isometric view of a second embodiment.

FIG. 4 is a list view for the method of automatically cleaning the undercarriage of a vehicle.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

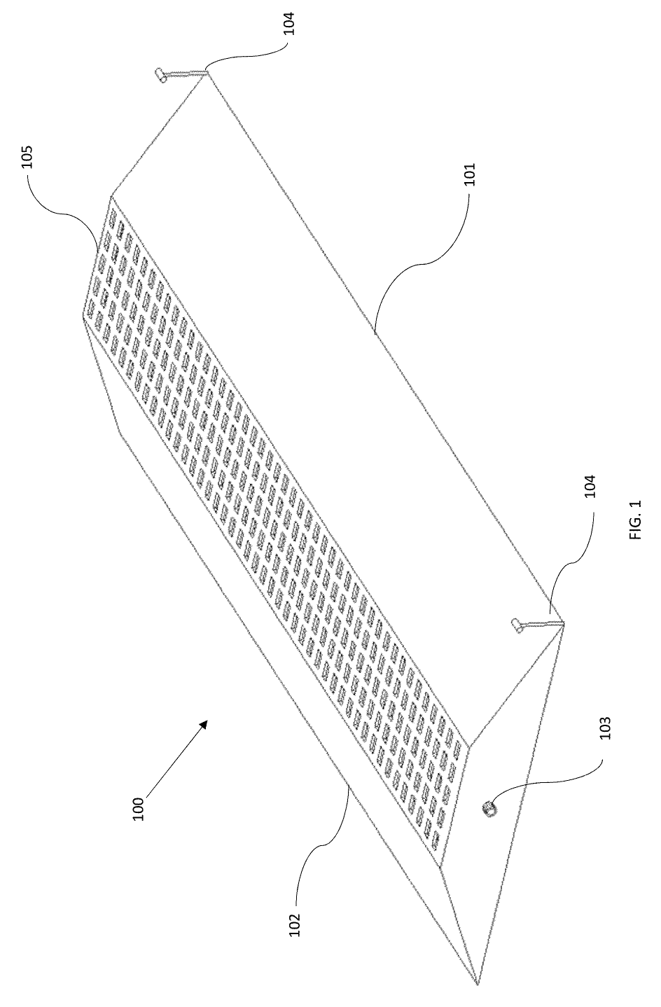

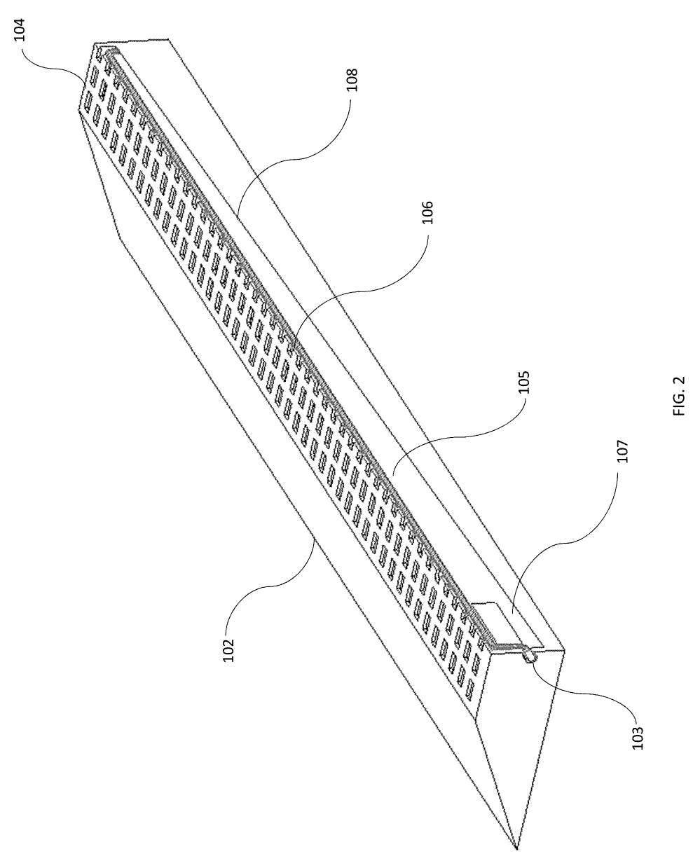

The personal vehicle undercarriage cleaning system is shown in its preferred embodiment in FIGS. 1 and 2 as having a housing 100 with a slanted leading edge 101 to allow a vehicle to drive up on to the housing 100. It also has a slanted trailing edge 102 allowing a vehicle to safely drive off the housing 100.

On the side of the housing 100 is a port 103 capable of receiving fluid from a remote source using any method known in the art, but preferably using a threaded port the size of a typical garden hose.

The port 103 is coupled to a hollow tube 105 or tubes that run longitudinally along the housing. The tubes are then coupled to a plurality of nozzles 106. These nozzles 106 are positioned so that when fluid is running through them they will spray the underside of a vehicle driving over or parked on the platform. In another embodiment of this system the nozzles 106 will be able to oscillate along the length of the vehicle to best remove as much unwanted snow and debris stuck to the bottom of the vehicle.

A sensor or sensors 104 using infrared, photoelectric, LIDAR or any of the technologies known in the art is placed on the leading edge of the housing. It is used to sense when a vehicle comes in contact with the housing and is passing over the sprayers. Using a computer control system connected to the sensors and the entry port it activates the flow of fluid. The sensors 104 will also detect when the vehicle has completely passed over the housing and thus shut off the flow of fluid.

In another embodiment a fluid reservoir 107 and pump assembly are stored in the housing 100 underneath the top surface 105. The pump assembly is coupled to the tubes 106 and uses the reservoir 107 as its fluid source. The computer control system is then connected to the pump and used to turn it on and off as a vehicle passes over the housing 100.

In the same embodiment the top surface 105 of the housing 100 has a grated surface made of any material with sufficient strength to hold a vehicle. The gaps from the grates allows any excess liquid, snow melt, or other debris to fall to the area beneath it while acting as a filter keeping out anything too big. Underneath the top surface 105 is a second surface 108 that is slanted to one end. This causes the excess liquid, snowmelt, and other debris to accumulate in one end. On this end is the reservoir 107 and pump assembly. The pump will be able to extract this excess liquid that is kept in the reservoir 107. This creates a closed loop system where it can reuse its own water to go through multiple loops of spraying without needing an outside fluid source. Another filter or multiple filters may need to be used to keep out any other unwanted debris and particles.

Since the fluid will be mixing with other debris and impurities it may be preferred to purify the fluid first before being sprayed on the undercarriage. The preferred method would be to use an ion exchange method to purify the water. Reference is made to U.S. Pat. No. 9,000,000 to Carroll, which is incorporated by reference herein in its entirety into the present disclosure. It is also possible to purify the fluid chemically either by the user adding chemicals to the reservoir or through an automated method. Any of the technologies known in the art can be used to accomplish this task.

The port 103 on the side of the housing can be used to drain the fluid in the reservoir if it becomes necessary. The fluid can then be replaced with new clean fluid by the means mentioned above.

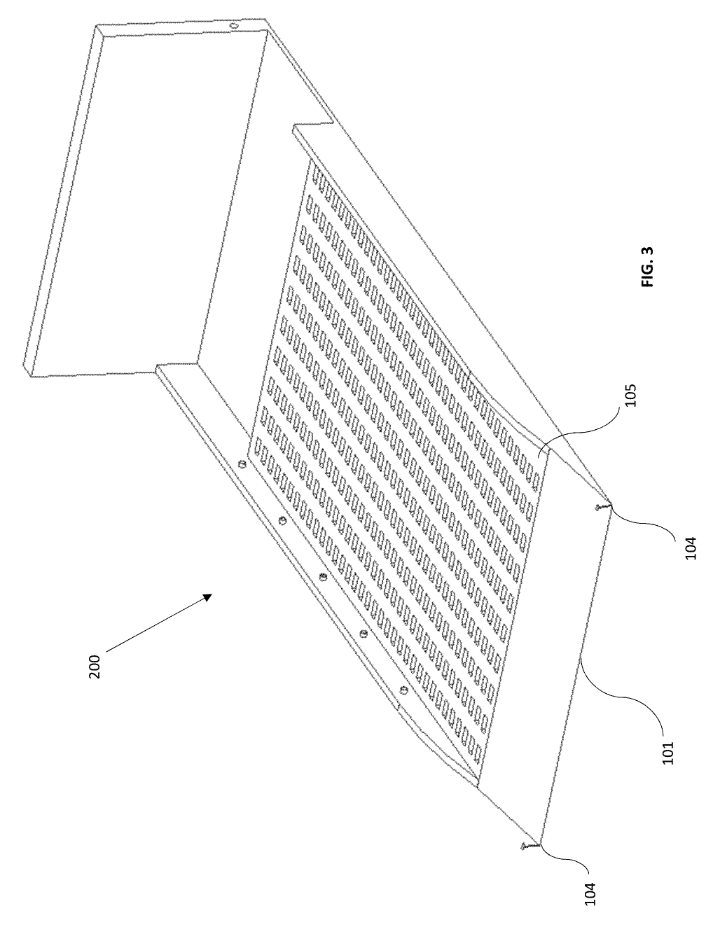

In the preferred embodiment the entire housing 100 is roughly the same size as a typical speed bump. In another embodiment as in FIG. 3 the housing 200 is roughly the size of a typical parking space allowing a 4-wheeled motor vehicle to be able to park on it. This will ensure the housing 200 catches all of the excess liquid, snowmelt, and other debris. By being able to catch more of the fluid it allows it to create a closed loop system that reuses its fluid easier. The housing 200 will now also protect a garage floor the same way that garage mats already known in the art and are used to keep garage floors from being damaged and dirtied by anything on the bottom of the vehicle.

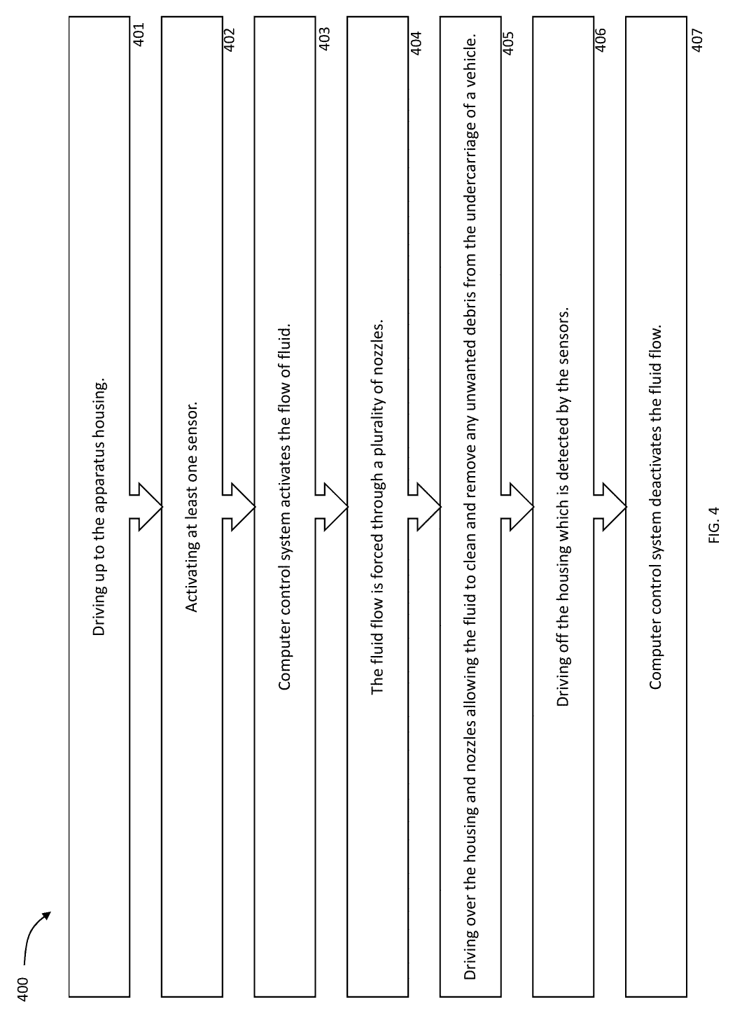

In FIG. 4 a method 400 for automatically cleaning the undercarriage of a motor vehicle is shown. The first step 401 is to approach the housing by driving up to it. Once the vehicle initially makes contact with the housing a sensor is activated 402. A controller coupled to the sensor is used to start the flow of fluid 403. Once the fluid is moving the nozzles then began spraying 404. The vehicle is then able to drive over the spraying nozzles, using the pressure from the fluid to remove any unwanted debris and residue from the undercarriage 405. The vehicle then drives off of the 100 housing 406 while the sensors 104 are used to determine when the vehicle has completely passed over the housing 100 and thus stop the spraying using the computer control system 407.

Those skilled in the art will recognize that numerous modifications can be made to the specific implementations described above. The implementations should not be limited to the particular limitations described. Other implementations may be possible.

1. An automated apparatus for cleaning the undercarriage of a vehicle comprising:
a trapezoidal shaped housing further comprising, an entry port for receiving fluid, a slanted leading and trailing edge capable of receiving a motor vehicle such that the entirety of the vehicle is able to pass over the housing,
a plurality of nozzles adapted to direct fluid at an undercarriage of a vehicle,
a hollow tube that allows internal fluid communication between the entry port and the nozzles,
at least one sensor in a position that allows it to determine when a vehicle is in contact with the housing,
a computer control system coupled to said sensor used to activate or deactivate the flow of fluid through the tube.

2. The apparatus of claim 1 wherein,
the housing further comprises a fluid reservoir, and a pump assembly fluidly coupled to the reservoir and the hollow tube.

3. The apparatus of claim 2 wherein,
a grate spans a top surface of the housing,
a second surface below the top surface is slanted downwardly towards the reservoir allowing excess liquid, snow melt, or other debris to collect in the reservoir.

4. A method for cleaning the undercarriage of a car using an automated apparatus that includes,
driving up to the apparatus housing,
activating at least one sensor by approaching the housing,
a computer control system then activates the flow of fluid through the apparatus,
the flowing fluid is forced through a plurality of nozzles aimed at the undercarriage of the vehicle,
Driving over the housing and nozzles using the pressure from the fluid to remove any unwanted debris from the bottom of the vehicle,
Driving off the housing which is detected by the sensor,
The computer control system deactivates the flow of fluid.
